(19) United States
(12) Patent Application Publication
(10) Pub. No.: US 2024/0382381 A1
(43) Pub. Date: Nov. 21, 2024

(54) CAPSULE SUPPORT AND METHODS OF USING SAME

(71) Applicant: Ratio Product Lab LLC, Atlanta, GA (US)

(72) Inventor: James Atticus FERGUSON, Atlanta, GA (US)

(21) Appl. No.: 18/667,783

(22) Filed: May 17, 2024

Related U.S. Application Data
(60) Provisional application No. 63/467,487, filed on May 18, 2023.

(51) Int. Cl. A61J 3/07

(52) U.S. Cl. CPC A61J 3/075

(57) ABSTRACT

Disclosed herein are systems and methods for weighing and filling a capsule with a device. The device includes a handle defining an outer side and an inner side, a panel coupled to the inner side of the handle at a first end thereof, and a shaft coupled to the first end of the handle and extending away therefrom. The device further includes a head coupled to a distal end of the shaft, and the head defines an aperture to receive a body of a capsule therein.

### CROSS REFERENCE TO RELATED APPLICATIONS

This application claims the benefit of and priority to U.S. Provisional Application No. 63/467,487, filed on May 18, 2023, which is incorporated by reference herein in its entirety.

### REFERENCE REGARDING FEDERALLY SPONSORED RESEARCH OR DEVELOPMENT

Not applicable.

### SEQUENCE LISTING

Not applicable.

### BACKGROUND

### 1. Field of the Disclosure

The present disclosure relates generally to systems for filling and weighing edible capsules, and more specifically, to handheld tools that are used to manually fill edible capsules.

### 2. Description of the Background

Edible capsules, such as gelatin, cellulose, and pullulan capsules, are a common form of medication and/or supplement delivery. Such capsules typically include a body portion that is filled with a desired substance, and a cap portion that is joined with the body portion to encapsulate the substance. Encapsulation of various substances into edible capsules is implemented in a variety of situations and settings, such as dividing bulk products into smaller portions or dosing small amounts of a substance at a particular weight. In a commercial setting, capsules are often pre-filled during manufacturing to ensure dosage uniformity at high volume and relieve the burden of manually filling the capsules from the consumer. To accomplish this, manufacturers typically use specialized capsule trays and automated capsule machines to fill tens or even hundreds of capsules at once. However, no process currently exists to weigh each capsule to ensure consistent filling at a commercial scale, meaning that if multiple capsules are filled the weight of the product is not known until they are capped. Further, pre-filling capsules using conventional encapsulation techniques eliminates a user's control over the dosage of the substance within a capsule. Correspondingly, there has been an increasing trend in recent years for users to manually weigh and fill their own individual capsules to achieve a greater degree of control over capsule content and dosing.

Individual capsule filling is however quite difficult due to the curved shape of traditional capsules that makes them difficult to grasp and manipulate during weighing, filling, and encapsulation. For example, gelatin capsules are often small and exhibit spring-like mechanics that can cause a portion of the capsule, e.g., a body portion or a head portion, to slip from a user's grasp. Further, traditional capsules have hollow or thin walls that are easily crushed, for example, when being pinched between a user's fingers. Handheld filling tools, such as scoops or spatulas, have been developed to make manual capsule filling easier, but using such tools to fill individual capsules is time consuming, especially if filling capsules in batches. Moreover, users still suffer from the problems associated with stabilizing and grasping capsules during filling due to the small sizes and shapes of edible capsules, which can result in increased wastage due to spilled substances and/or capsule breakage during filling.

Accordingly, there is a need for improved systems and methods for filling individual edible capsules based on their size that results in more efficient processes for filling and weighing, and encapsulation.

### SUMMARY

In some embodiments, a device for weighing and filling a capsule is provided. The device includes a handle defining an outer side and an inner side, a panel coupled to the inner side of the handle at a first end thereof, and a shaft coupled to the first end of the handle and extending away therefrom. The device further includes a head coupled to a distal end of the shaft, and the head defines an aperture to receive a body of a capsule therein.

In some embodiments, a device for weighing and filling a capsule is provided. The device includes a handle defining an outer side, an inner side, a first top side, and a first bottom side. The device further includes a panel coupled to the inner side of the handle at a first end thereof, the panel defining a second top side and a second bottom side. The device further includes a shaft coupled to the first end of the handle and extending away therefrom, and a head is coupled to a distal end of the shaft. The first bottom side and the second bottom side are planar, and the first bottom side is flush with the second bottom side such that the device defines a planar surface.

In some embodiments, a method of filling and weighing a capsule with a device is provided. The method includes removably coupling a body of a capsule to a head of a device, placing the device on a scale to establish a tare weight of the device and the capsule, and depositing a substance into the body of the capsule by dragging the head of the device through the substance. The method further includes placing the device on the scale to confirm a net weight of the substance disposed within the body of the capsule.

Various alternative implementations of the foregoing aspects are disclosed. The foregoing various aspects may be combined in any manner without limitation. The foregoing and other aspects and advantages of the disclosure will appear from the following description. In the description, reference is made to the accompanying drawings, which form a part hereof, and in which there is shown by way of illustration a preferred configuration of the disclosure. Such configuration does not necessarily represent the full scope of the disclosure, however, and reference is made therefore to the claims herein for interpreting the scope of the disclosure.

### BRIEF DESCRIPTION OF THE DRAWINGS

The present disclosure will be better understood and features, aspects, and advantages other than those set forth above will become apparent when consideration is given to the following detailed description thereof. Such detailed description makes reference to the following drawings.

FIG. 1 is a chart of edible capsule sizes, fill weights, and dimensions in accordance with aspects of the present disclosure;

FIG. 2 is a side view of an example edible capsule in accordance with the aspects of present disclosure;

FIG. 3 is an isometric view of a first embodiment of a tool for manually filling an edible capsule in accordance with aspects of the present disclosure;

FIG. 4 is a top plan view of the tool of FIG. 3;

FIG. 5 is a bottom plan view of the tool of FIG. 3;

FIG. 6 is a cross-sectional view of the tool of FIG. 3 taken through line 6-6 of FIG. 4;

FIG. 7 is an isometric view of a second embodiment of a tool for manually filling an edible capsule in accordance with aspects of the present disclosure;

FIG. 8 is a top plan view of the tool of FIG. 7;

FIG. 9 is a bottom plan view of the tool of FIG. 7;

FIG. 10 is a schematic illustration of an assembled capsule disposed within a recess defined within the tool of FIG. 3;

FIG. 11 is a schematic illustration of a disassembled capsule secured to a protrusion and a head of the tool of FIG. 3;

FIG. 12 is a schematic illustration of a cap of a capsule loosely coupled to a body of a capsule that is secured to a head of the tool of FIG. 3;

FIG. 13 is a schematic illustration of a cap of a capsule tightly coupled to a body of a capsule that is secured to a head of the tool of FIG. 3;

FIG. 14 is a schematic illustration of examples of differently sized tools for manually filling a capsule in accordance with aspects of the present disclosure; and

FIG. 15 is a flowchart representation of an example method of weighing and filling an edible capsule using the tool of FIG. 3.

Before the embodiments of the disclosure are explained in detail, it is to be understood that the disclosure is not limited in its application to the details of construction and the arrangement of the components set forth in the following description or illustrated in the drawings. Aspects of the disclosure are capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE DRAWINGS

The features, aspects and advantages are described below with reference to the drawings, which are intended to illustrate but not to limit the present disclosure. While the systems disclosed herein may be embodied in many different forms, several specific embodiments are discussed herein with the understanding that the embodiments described in the present disclosure are to be considered only exemplifications of the principles described herein, and the disclosure is not intended to be limited to the embodiments illustrated. Also, it is to be understood that the phraseology and terminology used herein are for the purpose of description and should not be regarded as limiting. Throughout the disclosure, the terms “about” and “approximate” mean plus or minus 5% of the number or value that each term precedes. In the drawings, like reference characters denote corresponding features consistently throughout the drawings. As used herein in the context of geometric descriptions, unless otherwise limited or defined, “substantially” indicates correspondence to a particular shape or dimension within conventional manufacturing tolerances for components of a similar type or that are formed using similar processes. In this regard, for example, “substantially round” can indicate a profile that deviates from a circle to within acceptable manufacturing tolerances.

Also, while the terms “front,” “back,” “top,” “bottom,” “side,” “forward,” and “rearward” and the like may be used in this specification to describe various example features and elements, these terms are used herein as a matter of convenience, e.g., based on the example orientations shown in the figures and/or the orientations in typical use. Unless otherwise stated, nothing in this specification should be construed as requiring a specific three dimensional or spatial orientation of structures in order to fall within the scope of the claims.

The present disclosure is related to handheld devices, e.g., utensils or tools, which allow a user to weigh and fill dissolvable or edible capsules with a desired substance. The process of assembling capsules is called encapsulation. Users may wish to fill one capsule at a time to maximize control over capsule contents. However, manual capsule filling is difficult due to the size and shape of traditional capsules and the individual dexterity of the user. One conventional filling device that has been developed is a lab spatula, which typically includes a rounded scoop end and a tapered or flat end. To fill a capsule with a lab spatula, a user typically removes a substance from a container using the spatula and then weighs the substance using a scale. After a desired weight is achieved, the user scoops the substance up from the scale, e.g., using the scoop end or the flat end, and deposits the substance in the capsule, e.g., a cavity defined by a body portion of the capsule. Due to the size of the capsule, the amount of a substance that can be deposited in the cavity with a lab spatula is quite small, thus requiring the user to repeat this step multiple times to fill a single capsule. Moreover, high speed or automated filling systems that are used to fill capsules at a commercial scale limit an individual user's control over the contents of a capsule, and these advanced systems are generally not available to individual users and require professional training to use.

The purpose of the following disclosure is to provide systems and methods to assist users with weighing and filling individual capsules to maintain control over the contents of the capsules and streamline the filling process. More specifically, the following disclosure provides a handheld capsule filling tool that includes a shaft with a head to hold a body portion of a capsule, and a handle with a protrusion to hold a cap portion of a capsule. That is, the capsule and the filling tool are coupled and weighed together, which helps to simplify the taring/weighing procedure. The size and shape of the filling tool also simplifies the filling procedure, as a user can scoop a desired substance directly into the body portion of the capsule by inserting and, for example, scooping or dragging the shaft through a container. This in turn further reduces the time spent filling and weighing a substance, leading to greater filling efficiency and improved user satisfaction.

In the description that follows, reference is made to one or more tool structures. It is contemplated that any of the disclosed structures may be constructed from any polymer, composite, plastic, injection molded plastic, and/or metal/alloy material, without departing from the scope of the disclosure. Additionally, it is contemplated that any manufacturing methodology may be utilized, without departing from the scope of the disclosure. For example, one or more of welding, e.g., high frequency, ultrasonic welding, or laser welding of fabric, or metal/alloy welding, gluing, stitching, molding, injection molding, blow molding, stamping, deep-drawing, casting, die-casting, rotational molding, or additive manufacturing processes such as 3D printing may be used, as well as various finishing processes, including drilling, deburring, grinding, polishing, sanding, or etching processes, among many others, may be utilized to construct the various tool structures, or portions thereof, described throughout the disclosure.

Further, it should be understood that the teachings herein are not limited to any particular filling substance or material. That is, it is contemplated that any suitable filling material may be used to fill a capsule, including, for example, a variety of medicines, vitamins, dietary supplements, and/or minerals provided in the form of solid powders and/or crystalline materials. Moreover, the teachings herein are applicable to tools for filling capsules of various sizes and compositions, such as capsules comprising animal-based gelatin and/or vegetable-based pectin.

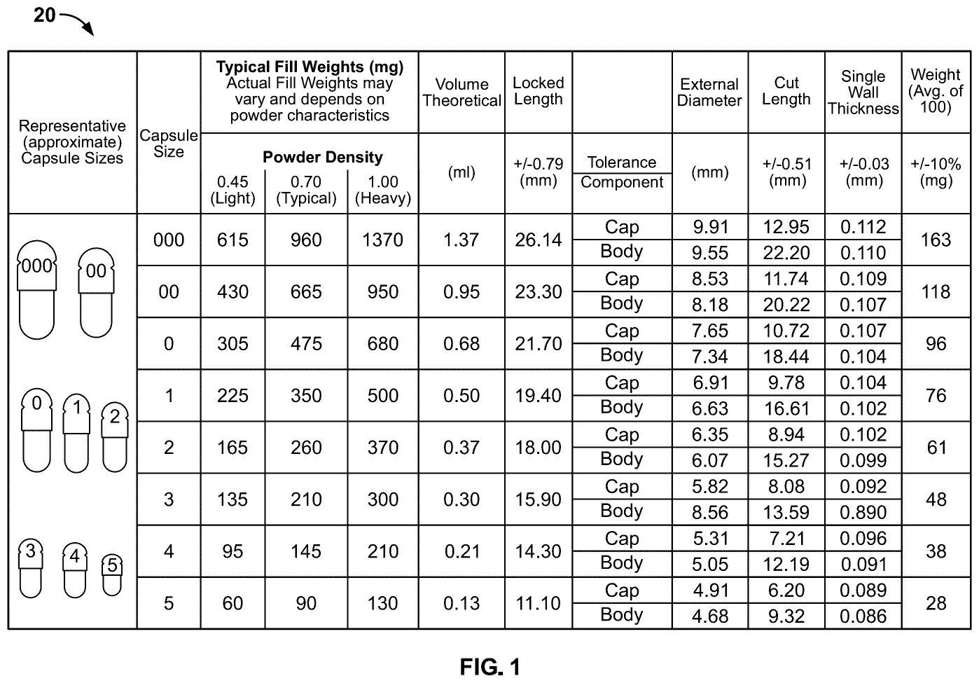

Referring now to FIG. 1, a table 20 is illustrated which includes various capsule sizes, fill weights, volumes, and assembled lengths. It is contemplated that a capsule can be of any particular size, such as international capsule sizes 000, 00, 0, 1, 2, 3, 4, and 5. Each of the international capsule sizes 000, 00, 0, 1, 2, 3, 4, and 5 have well known dimensions, as shown in the table 20. Sizes for capsules range from a small size 5, to a larger size 4 and so on, with 000 being the largest size. Accordingly, capsules generally have capacities of between about 50 milligrams (mg) and about 1500 mg, volumes of between about 0.10 milliliters (mL) and about 1.40 mL, and assembled lengths of between about 9.00 millimeters (mm) and about 27.0 mm, as illustrated in the table 20 of FIG. 1. However, it is contemplated that these values may vary between capsule manufacturers.

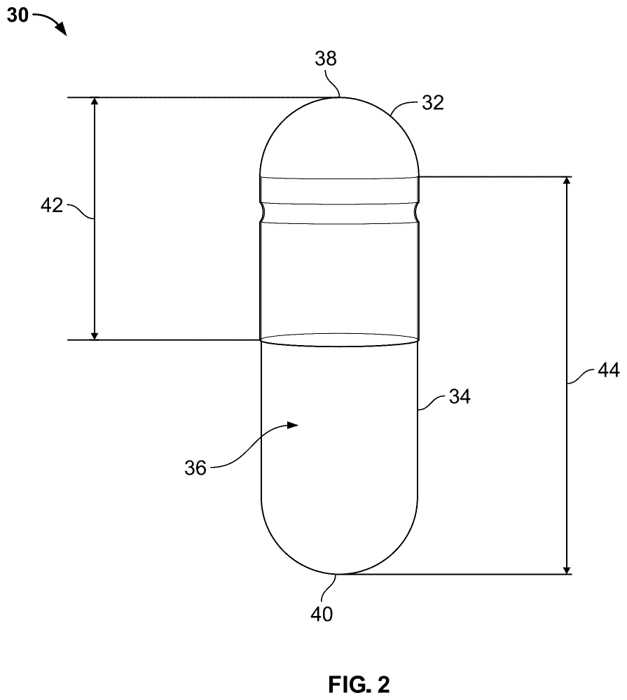

Now referring to FIG. 2, an example capsule 30 is illustrated. As discussed above, capsules can be manufactured using a variety of different sizes, shapes, and compositions. For examples, capsules may be provided as gelatin capsules, plant-based capsules, hard capsules, soft capsules, etc. Generally, however, capsules define an ovular profile characterized by a cylinder with hemispherical ends. In the non-limiting illustrated example, the capsule 30 comprises two parts which are referred to herein as a cap 32, i.e., a shorter and wider portion of the capsule 30, and a body 34, i.e., a larger and narrower portion of the capsule 30. The body 34 defines a volume 36 in which a desired substance is deposited to fill the capsule 30. The cap 32 is configured to be secured on the body 34 to seal the volume 36 of the body 34 from the environment.

During encapsulation, i.e., when the capsule 30 is assembled to seal the volume 36, the cap 32 is placed onto the body 34 and a compressive force is applied to either end, e.g., a first end 38 located at a distal-most point of the cap 32 and a second end 40 located an opposite, proximal-most point of the body 34, of the capsule 30 until the cap 32 is secured to the body 34. This press-fit, sealing interaction between the cap 32 and the body 34 is provided by manufacturing the cap 32 to have a larger diameter than the body 34 or at least a portion of the body 34. Further, the cap 32 defines a cap or first length 42 that is measured in a direction that is parallel to a line (not shown) that extends through the first end 38 and the second end 40 of the capsule, and the body 34 defines a body or second length 44 that is measured in the same direction as the first length 42 and that is greater than the first length 42. In some examples, the first length 42 is between about 45% and about 65% of the second length 44, or between about 50% and about 60% of the second length 44, or between about 55% and about 60% of the second length 44. Additional examples of differences between cap lengths and body lengths of capsules are illustrated in FIG. 1 under the column “Cut Length.”

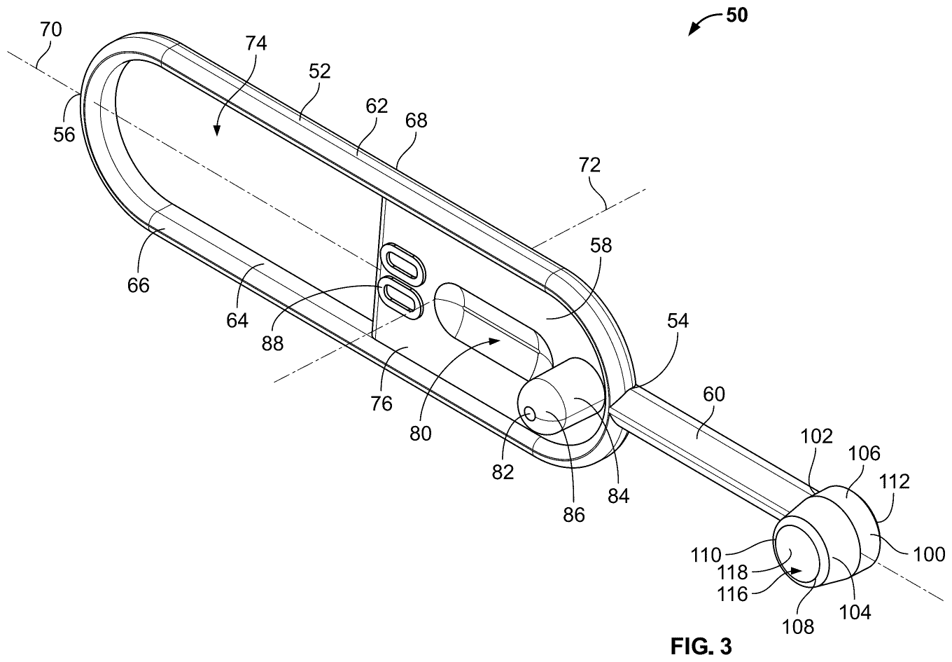

Due to the small size of traditional capsules, it is difficult to fill and seal individual capsules without specialized machinery, as discussed above. Further, it can be difficult to keep track of portions of a disassembled capsules, e.g., the cap and the body, when weighing and filling individual capsules. To address these and other shortcomings of traditional encapsulation techniques, the following disclosure provides a device, which may be configured as an encapsulation tool or capsule filling tool. FIGS. 3-6 illustrate various aspects of an implementation of a tool 50, which may be configured as an encapsulation tool or capsule filling tool, according to aspects of the present disclosure. In some examples, the tool 50 comprises a handle 52 defining a first end 54 and a second end 56 opposite the first end 54, a panel 58 coupled to the handle 52, and a shaft 60 that extends outward from the handle 52. The handle 52 defines an outer side 62, an inner side 64, a top side 66, and a bottom side 68 opposite the top side 66. The tool 50 also defines a longitudinal axis 70 that extends through the first end 54 and the second end 56 of the handle 52. In addition, a transverse axis 72 extends through the top side 66 and the bottom side 68 of the handle 52 in a direction that is perpendicular with respect to the longitudinal axis 70. In some examples, the longitudinal axis 70 and the transverse axis 72 define a corresponding plane (not shown) of the tool 50.

Further, the outer side 62 and the inner sides 64 include curved segments at the first end 54 and the second end 56 such that the handle 52 defines a substantially ovular profile. Put another way, the first and second ends 54, 56 of the handle 52 define curved segments that are coupled to one another by linear segments defined by the outer and inner sides 62, 64 of the handle 52. Thus, the handle 52 defines an ergonomic profile that reduces or prevents strain on a user who is wielding the tool 50. However, it is contemplated that the handle 52 may be formed as any suitable shape or combination of shapes, such as, e.g., a rectangular handle, a cylindrical handle, a flared handle, a curved handle, etc. In some examples, the handle 52 defines an opening 74 that is enclosed by the inner side 64 of the handle 52. The opening 74 is provided to decrease the overall weight of the tool 50, which in turn makes the tool 50 easier for a user to wield. In some examples, the opening 74 extends between the first end 54 and the second end 56 of the handle 52, or the opening 74 extends along a portion of the handle 52. In the non-limiting example, the opening 74 is enclosed by the inner side 64 of the handle 52 and the panel 58.

Similar to the outer side 62, the top side 66 of the handle 52 defines a substantially ovular or curved profile to make the handle 52 more comfortable to grip, e.g., when a user is wielding the tool 50. However, the bottom side 68 of the handle 52 is substantially planar or flat, as illustrated in FIG. 5. In some examples, forming the bottom side 68 as a substantially planar surface increases the stability of the tool 50 to when placed on a flat surface, e.g., when weighing the tool 50 on a scale, such as a table scale. As will be discussed below in greater detail, it is an advantage of the present disclosure that the tool 50 includes a substantially planar bottom surface to allow the tool 50 and a capsule retained thereon to be weighed together, thus simplifying the weighing process during/after filling.

Referring now to FIGS. 3-5, the panel 58 is coupled to the inner side 64 of the handle 52 at the first end 54, although it is contemplated that the panel 58 may be coupled to the second end 56 or at a position between the first end 54 and the second end 54 in other examples. Accordingly, it will be understood that the inner side 64 of the handle 52 surrounds the panel 58 and the opening 74. In some embodiments, the panel 58 is a removable panel that can be slid or snapped in and out of the opening 74, or the panel 58 is unitary with the handle 52 to streamline manufacturing of the tool 50. Further, the panel 58 defines a top side 76, i.e., a side facing the same direction as the top side 66 of the handle 52, and a bottom side 78, i.e., a side facing the same direction as the bottom side 68 of the handle 52. In some examples, the bottom side 78 of the panel 58 is flush with the bottom side 68 of the handle 52 such that the bottom side 78 of the panel 58 is also substantially planar or flat, as illustrated in FIG. 5. As discussed above, forming the bottom side 78 as a substantially planar surface increases the stability of the tool 50 when placed on a flat surface, e.g., a platform of a scale.

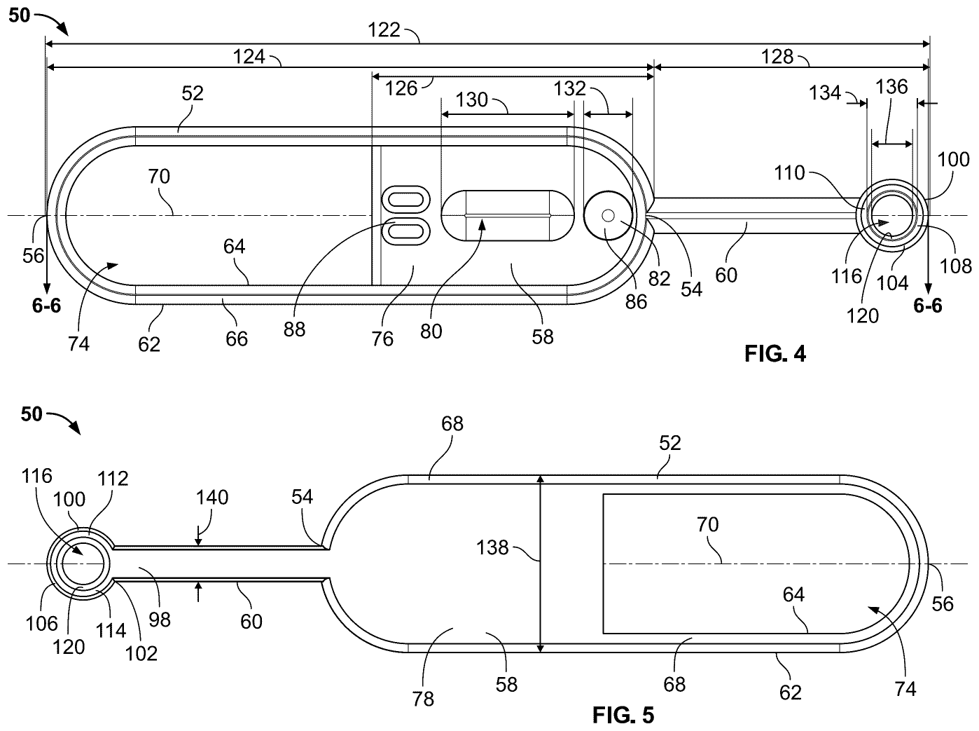

Referring now to FIGS. 3 and 4, a recess 80, e.g., an ovular recess, is defined within the top side 76 of the panel 58, and the recess 80 provides a location for a capsule to be placed on the top side 76 of the panel 58 (see, e.g., FIG. 10). The recess 80 is correspondingly shaped to the profile of a capsule such that a capsule is prevented from falling off of the panel 58 when inserted into the recess 80. More specifically, the recess 80 is formed to correspond to a particular capsule size, e.g., the international capsule sizes 000, 00, 0, 1, 2, 3, 4, and 5 (see e.g., FIG. 1), to optimize the retention characteristics of the recess 80. In some examples, the recess 80 is located centrally within the top side 66 of the handle 52, i.e., axially aligned along the longitudinal axis 70, or the panel 58 defines multiple recesses to receive multiple capsules that are located at various locations on the panel 58.

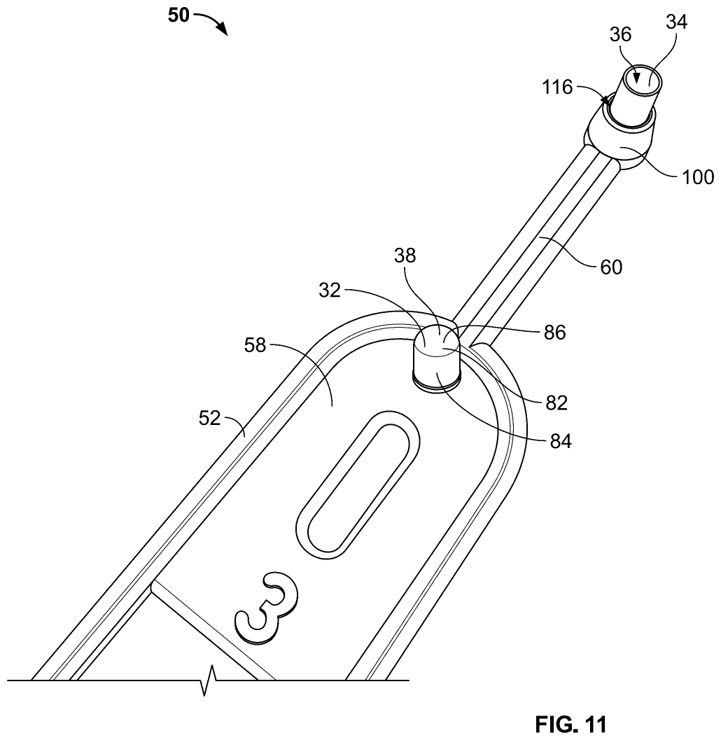

Relatedly, a protrusion 82 extends upward from the top side 76 of the panel 58, and the protrusion can be shaped so as to receive a cap of a capsule while a body of the capsule is being filled (see, e.g., FIG. 11). As such, the protrusion 82 defines a profile that corresponds to the cap of a capsule. In particular, the protrusion 82 includes a cylindrical base 84 and a hemispherical end portion 86 which receives a distal end of a cap of a capsule, e.g., the first end 38 of the capsule 30 (see FIG. 1). Accordingly, the hemispherical end portion 86 defines a first radius of curvature that is substantially similar to a second radius of curvature defined by a cap of a capsule. In the non-limiting example illustrated in FIGS. 3 and 4, the protrusion 82 is positioned forward of, i.e., closer to the first end 54 of the handle 52 than, the recess 80, and the protrusion 82 is axially aligned with the recess 80 along the longitudinal axis 70, although it is contemplated that the protrusion 82 may be positioned rearward of the recess 80 or offset from the longitudinal axis 70 in some examples.

In some embodiments, the protrusion 82 is formed as a unitary component with the top side 76 of the panel 58 during an additive manufacturing process, and the protrusion 82 is formed to correspond to a particular capsule size, e.g., the international capsule sizes 000, 00, 0, 1, 2, 3, 4, and 5 (see, e.g., FIG. 1), which can simplify the manufacturing process of the tool 50. In some examples, however, the protrusion 82 is removably coupled to the top side 76 of the panel 58 via a fastening mechanism, e.g., a fastener, a lock-and-key fit between the protrusion 82 and the panel 58, an interference fit between the panel 58 and the protrusion 82, etc. Further, the protrusion 82 itself may include a threaded portion (not shown) that is configured to be screwed into a corresponding threaded cavity (not shown) defined in the panel 58. This may be particularly advantageous if a user is filling differently sized capsules with the tool 50, as the user can switch a first removable protrusion corresponding to a first capsule size with a second removable protrusion corresponding to a second capsule size. Correspondingly, it is contemplated that the protrusion 82 may be constructed from any suitable material, e.g., a polymer, a composite, a plastic, an injection molded plastic, a metal/alloy material, rubber, and/or any combination thereof. Additional aspects of the protrusion 82 will be discussed below in greater detail.

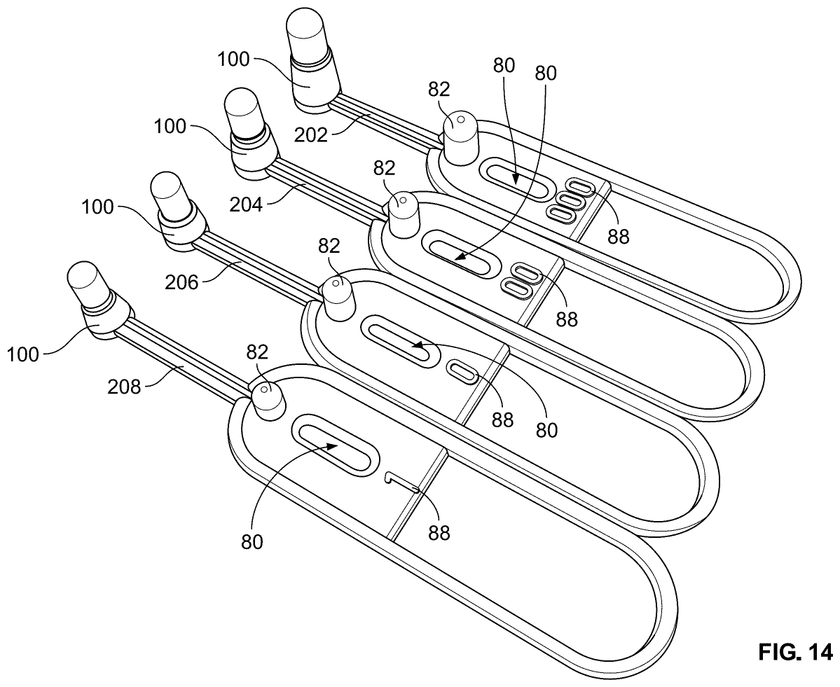

In some examples, and with continued reference to FIGS. 3 and 4, the top side 76 of the panel 58 further includes a label 88 disposed thereon that corresponds to a particular capsule size, e.g., the international capsule sizes 000, 00, 0, 1, 2, 3, 4, and 5 (see e.g., FIG. 1). In the non-limiting example, the label 88 is provided as “00” corresponding to international capsule size 00, although it is contemplated that the label 88 can be provided as the other international capsule sizes in other examples (see, e.g., FIG. 14). The label 88 is included to make it clear to a user which capsule size the tool 50 is compatible with, which can be helpful, for example, if the user has multiple tools of different sizes and/or is filling capsules of different sizes. In the non-limiting illustrated example, the label 88 is positioned rearward of, i.e., closer to the second end 56 of the handle 52 than, the recess 80, and the protrusion 82 is axially aligned with the recess 80 and the protrusion 82 along the longitudinal axis 70. In some examples, the label 88 may be positioned forward of the recess 80 and/or the protrusion 82 or offset from the longitudinal axis 70.

Referring again to FIGS. 3-5, the shaft 60 is coupled to the outer side 62 of the handle 52 and extends outwardly therefrom, i.e., away from the handle 52. In particular, the shaft 60 is coupled to the first end 54 of the handle 52, meaning that the panel 58 and the shaft 60 are coupled to the same end of the handle 52 as one another. Correspondingly, the shaft 60 and the opening 74 are located at opposite ends of the handle 52. In some examples, the shaft 60 extends in a direction that is parallel with the longitudinal axis 70, or the shaft 60 extends along the longitudinal axis 70. The shaft 60 defines a substantially cylindrical profile, although it is contemplated that the shaft 60 could be formed as another suitable shape or combination of shapes, e.g., a rectangular shaft, a triangular shaft, a concavely/convexly shaft, etc. In some examples, the shaft 60 defines a substantially planar bottom side 98 that is flush with the bottom side 68 of the handle 52 and/or the bottom side 78 of the panel 58. As discussed above, it is an advantage of the present disclosure that the tool 50 includes a substantially planar bottom surface to increase the stability of the tool 50 when placed on flat surface, e.g., a platform of a scale. In some aspects, the shaft 60 defines a unitary component with the handle 52 and/or the panel 58, or the shaft 60 is removable coupled to the handle 52 to allow shafts of different lengths to be used.

Further, a head 100 is coupled to the shaft 60 at a distal end 102 thereof, i.e., an end of the shaft 60 opposite the first end 54 of the handle 52. As will be discussed below in greater detail, the head 100 is generally configured to retain a body of a capsule therein, thus allowing the capsule to be easily filled by scooping a desired substance out of a container using the tool 50. The head 100 includes a conical portion 104 and a cylindrical portion 106 that are axially aligned with one another in a direction that is parallel with respect to the transverse axis 72. The conical portion 104 extends upward from the cylindrical portion 106 and terminates in an upper rim 108 that defines a top end 110 of the head 100. Correspondingly, the cylindrical portion 106 defines a bottom end 112 of the head 100 which includes a substantially planar bottom surface 114 that is flush with the bottom side 98 of the shaft 60. In addition, the head 100 defines an aperture 116 that extends through the conical portion 104 and the cylindrical portion 106 in a direction that is parallel with respect to the transverse axis 72, the aperture 116 to receive a body of a capsule therein. That is, the conical portion 104 and the cylindrical portion 106 define an inner wall 118 of the head 100 which abuts a body of a capsule when a capsule is inserted into the aperture 116. For example, a body of a capsule is pressed into the aperture 116 to create an interference fit between the body and the head 100, which in turn secures the body to the head 100 and allows a user to scoop a desired substance into the body with the tool 50. To provide this interference fit, the cylindrical portion 106 defines a lower rim 120 that limits the size of the aperture 116, as will be discussed below in greater detail.

Referring now to FIG. 4, a top plan view is illustrated of the tool 50. Various dimensions of the tool 50 are shown, including an overall length 122 of the tool 50, a length 124 of the handle 52, a length 126 of the panel 58, a length 128 of the shaft 60, a length 130 of the recess 80, a diameter 132 of the protrusion 82, a diameter 134 of the upper rim 108 of the head 100, and a diameter 136 of the lower rim 120. Each of the lengths 122, 124, 126, 128, 130 and diameters 132, 134, 136 of the tool 50 are measured in a direction that is parallel with respect to the longitudinal axis 70. As such, it will be appreciated that a length may be measured in a direction that is parallel with respect to the longitudinal axis 70. In the illustrated embodiment, the overall length 122 is illustrated as a maximum length of the tool 50.

In some examples, the length 124 of the handle 52 is between about 50% and about 100% of the overall length 122 of the tool 50, or between about 60% and about 75% of the overall length 122 of the tool 50, or between about 65% and about 70% of the overall length 122 of the tool 50, or about 68% of the overall length 122 of the tool 50. In some examples, the length 126 of the panel 58 is between about 10% and about 75% of the overall length 122 of the tool 50, or between about 25% and about 50% of the overall length 122 of the tool 50, or between about 25% and about 35% of the overall length 122 of the tool 50, or about 32% of the overall length 122 of the tool 50. In some examples, the length 128 of the shaft 60 is between about 10% and about 75% of the overall length 122 of the tool 50, or between about 25% and about 50% of the overall length 122 of the tool 50, or between about 25% and about 35% of the overall length 122 of the tool 50, or about 32% of the overall length 122 of the tool 50. In some examples, the length 126 of the panel 58 is between about 25% and about 75% of the length 124 of the handle 52, or between about 40% and about 60% of the length 124 of the handle 52, or between about 45% and about 50% of the length 124 of the handle 52, or about 46% of the length 124 of the handle 52.

Further, in some examples, the length 130 of the recess 80 is between about 10% and about 75% of the length 126 of the panel 58, or between about 25% and about 50% of the length 126 of the panel 58, or between about 25% and about 35% of the length 126 of the panel 58, or about 32% of the length 126 of the panel 58. In some examples, the diameter is between about 5% and about 50% of the length 126 of the panel 58, or between about 10% and about 25% of the length 126 of the panel 58, or between about 15% and about 20% of the length 126 of the panel 58, or about 18% of the length 126 of the panel 58. In some examples, the diameter 134 of the upper rim 108 of the head 100 is between about 75% and about 125% of the diameter 132 of the protrusion 82, or between about 100% and about 125% of the length 130 of the diameter 132 of the protrusion 82, or between about 90% and about 110% of the diameter 132 of the protrusion 82, or about 100% of the diameter 132 of the protrusion 82. In some examples, the diameter 136 of the lower rim 120 of the head 100 is between about 75% and about 100% of the diameter 134 of the upper rim 108, or between about 75% and about 85% of the length 130 of the diameter 134 of the upper rim 108, or between about 80% and about 85% of the diameter 134 of the upper rim 108, or about 80% of the diameter 134 of the upper rim 108.

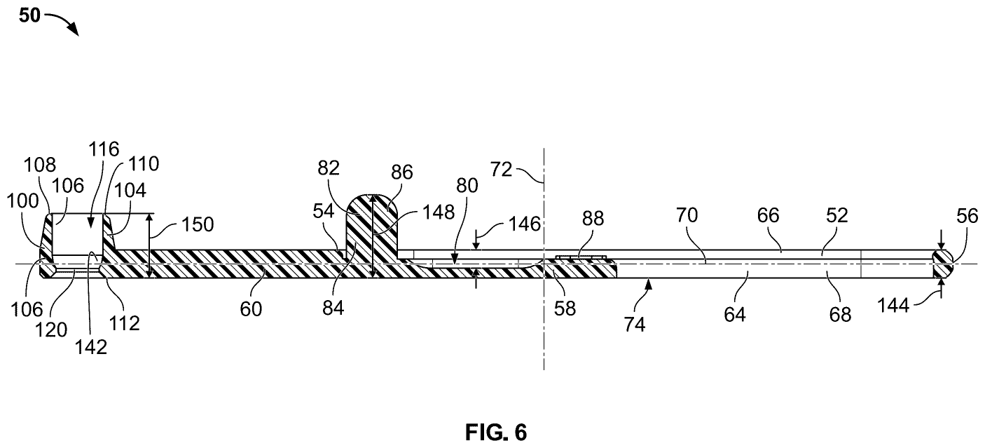

Referring now to FIG. 5, a bottom plan view is illustrated of the tool 50 in which additional dimensions are shown, including a width 138 of the handle 52 and a width 140 of the shaft 60. Each of the widths 138, 140 of the tool 50 are measured in a direction that is perpendicular with respect to the longitudinal axis 70 and the transverse axis 72 (see FIG. 6). As such it will be appreciated that a width may be measured in a direction that is perpendicular with respect to the longitudinal axis 70 and the transverse axis 72 (see FIG. 6). With additional reference to FIG. 4, the width 138 of the handle 52 is between about 25% and about 50% of the length 124 of the handle 52, or between about 25% and about 35% of the length 124 of the handle 52, or between about 25% and about 30% of the length 124 of the handle 52, or about 30% of the length 124 of the handle 52. In some examples, the width 140 of the shaft 60 is between about 5% and about 25% of the length 128 of the shaft 60, or between about 5% and about 15% of the length 128 of the shaft 60, or between about 10% and about 15% of the length 128 of the shaft 60, or about 12% of the length 128 of the shaft 60.

Referring now to FIG. 6, a cross-sectional view is illustrated of the tool 50 taken through line 6-6 of FIG. 3. As discussed above, the conical portion 104 of the head 100 defines the upper rim 108, which defines a diameter, e.g., the diameter 134, that is greater than a diameter defined by the upper rim 120, e.g., the diameter 136. Put another way, the lower rim 120 decreases a width of the aperture 116 at the bottom end 112 of the head. In some aspects, the inner wall 118 of the head 100 tapers inward on either side of the lower rim 120 to form a seat 142 in which a body portion of a capsule contacts when a capsule is inserted into the aperture 116. Additional dimensions of the tool 50 are illustrated in FIG. 6, including a thickness 144 of the handle 52, a depth 146 of the recess 80, a thickness 148 of the protrusion 82, and a thickness 150 of the head 100. Each of the thicknesses 144, 148, 150 and the depth 146 of the tool 50 are measured in a direction that is parallel with respect to the transverse axis 72. As such it will be appreciated that a thickness and/or a depth may be measured in a direction that is parallel with respect to the transverse axis 72.

In some examples, the depth 146 of the recess 80 is between about 50% and about 75% of the thickness 144 of the handle 52, or between about 60% and about 70% of the thickness 144 of the handle 52, or between about 65% and about 70% of the thickness 144 of the handle 52, or about 68% of the thickness 144 of the handle 52. In some examples, the thickness 144 of the handle 52 is between about 25% and about 50% of the thickness 148 of the protrusion 82, or between about 30% and about 40% of the thickness 148 of the protrusion 82, or between about 30% and about 35% of the thickness 148 of the protrusion 82, or about 35% of the thickness 148 of the protrusion 82. In some examples, the thickness 144 of the handle 52 is between about 25% and about 75% of the thickness 150 of the head 100, or between about 35% and about 50% of the thickness 150 of the head 100, or between about 40% and about 50% of the thickness 150 of the head 100, or about 45% of the thickness 150 of the head 100.

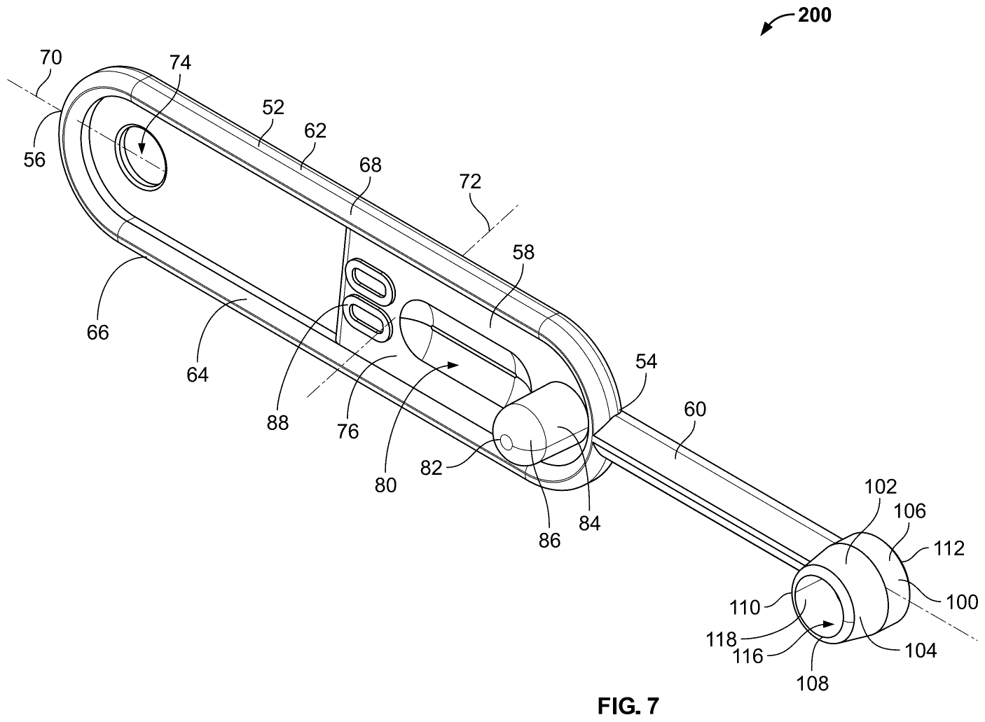

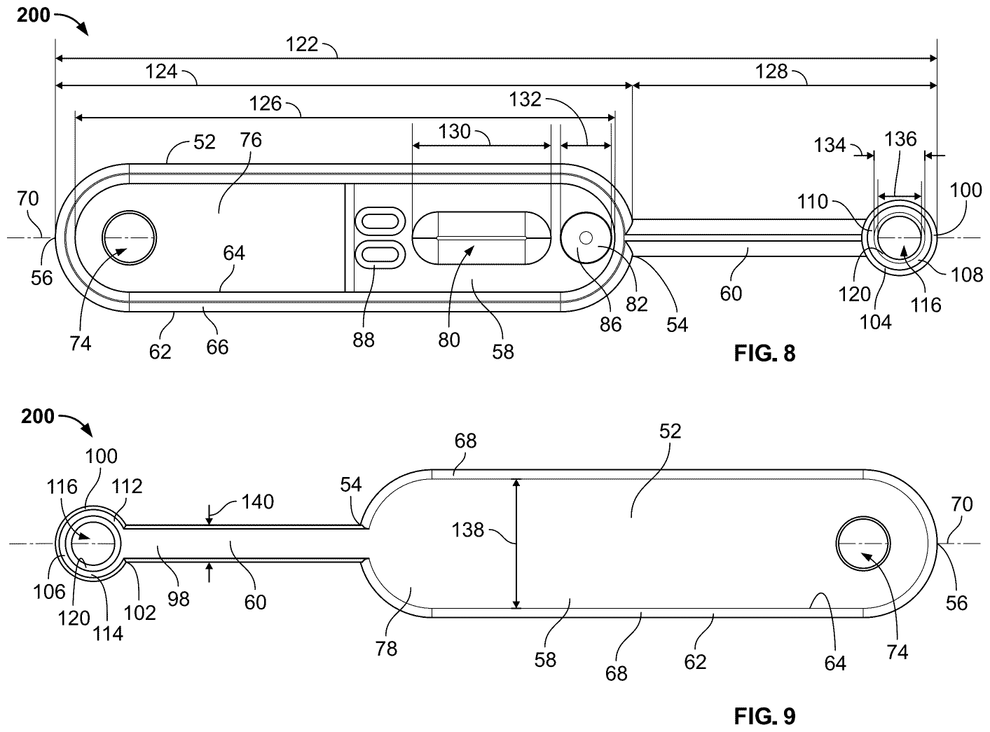

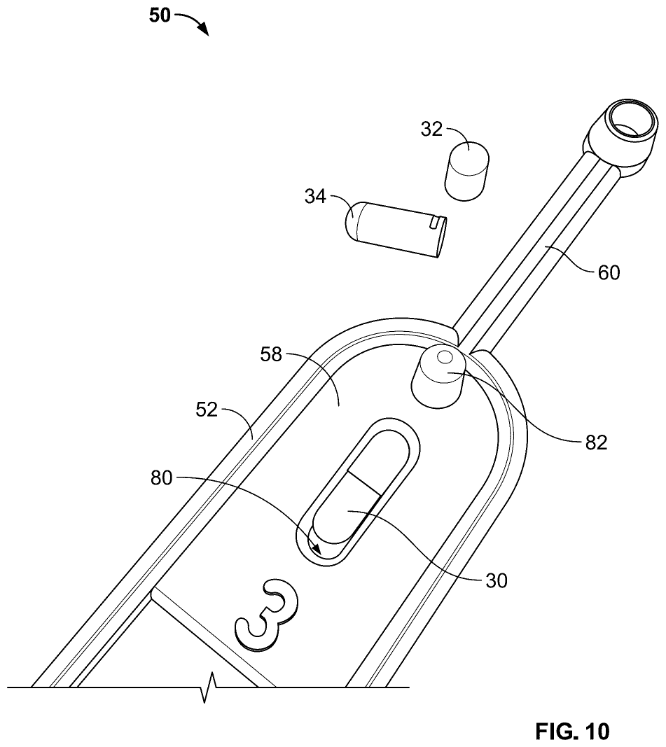

FIGS. 7-9 illustrate various aspects of an implementation of a tool 200, e.g., a capsule filling tool, according to another aspect of the present disclosure. In this embodiment, elements that are shared with—i.e., that are structurally and/or functionally identical or similar to—elements present in the first embodiment (tool 50) are represented by like reference numerals. In the interest of brevity, some features of this embodiment that are shared with the embodiment of FIGS. 3-6 are numbered or labeled in FIGS. 7-9 but are not discussed in the specification. However, reference is made to a list of reference numerals used in the description herein. In the illustrated non-limiting example, the panel 58 spans the entire periphery of the inner side 64 of the handle 52. Further, the opening 74 is provided as a substantially circular opening, such as a keyring hole. While the handle 52, panel 58, and shaft 60 of the tools 50, 200 have varying lengths 122, 124, 126, 128, 130 and widths 138, 140, these differences relate to the profile of the tools 50, 200. However, the various dimensional relationships between the lengths 122, 124, 126, 128, 130 and widths 138, 140 of the handle 52, panel 58, and shaft 60 of the tools 50, 200 may vary within the following ranges.

In some examples, the length 126 of the panel 58 is between about 50% and about 75% of the overall length 122 of the tool 50, or between about 55% and about 65% of the overall length 122 of the tool 50, or about 62% of the overall length 122 of the tool 50. In some aspects, the width 138 of the handle 52 is between about 10% and about 50% of the length 124 of the handle 52, or between about 20% and about 30% of the length 124 of the handle 52, or about 25% of the length 130. In some examples, the width 140 of the shaft 60 is between about 5% and about 25% of the length 128 of the shaft 60, or between about 10% and about 20% of the length 128 of the shaft 60, or about 12% of the length 128 of the shaft 60. In some examples, the width 140 of the shaft 60 is between about 5% and about 50% of the width 138 of the handle 52, or between about 20% and about 30% of the width 138 of the handle 52, or about 25% of the width 138 of the handle 52.

Referring now to FIG. 10, the recess 80 provides a location for a capsule, e.g., the capsule 30 having a cap 32 and a body 34, to be placed on the top side 76 of the panel 58. In particular, the recess 80 serves as a holding tray for the assembled capsule 30, which both allows a user to keep track of the assembled capsule 30 and provides an indication as to the international capsule size that the tool 50 is configured to receive. As discussed above, it will be understood that FIG. 10 illustrates a non-limiting example of the recess 80, and that the tool 50 may include multiple recesses to hold multiple capsules in some examples.

Referring now to FIG. 11, a schematic illustration is shown of a disassembled capsule, e.g., the capsule 30, secured to the tool 50. As discussed above, the cap 32 is pressed onto the protrusion 82, and the body 34 is pressed into the aperture 116 of the head 100. In some examples, the cylindrical base 84 of the protrusion 82 defines a slightly larger diameter, e.g., the diameter 136 (see FIG. 5), than the cap 32 to prevent the cap 32 from falling off of the protrusion 82 due to gravity. Relatedly, the hemispherical end portion 86 defines a radius of curvature that corresponds to a radius of curvature defined by the first end 38 of the capsule 30. Further, the second end 40 (see FIG. 2) of the capsule 30, i.e., the body 34, is inserted into the aperture 116 and pressed downward until the body 34 is secured within the head 100 via the interference fit provided by the lower rim 120 (see FIG. 5). This interference fit prevents the body 34 from dislodging from the head 100 unless intentionally removed by a user, which in turn allows a user to fill the body 34 by moving or dragging the head 100 through a desired substance, e.g., through a container that houses the desired substance.

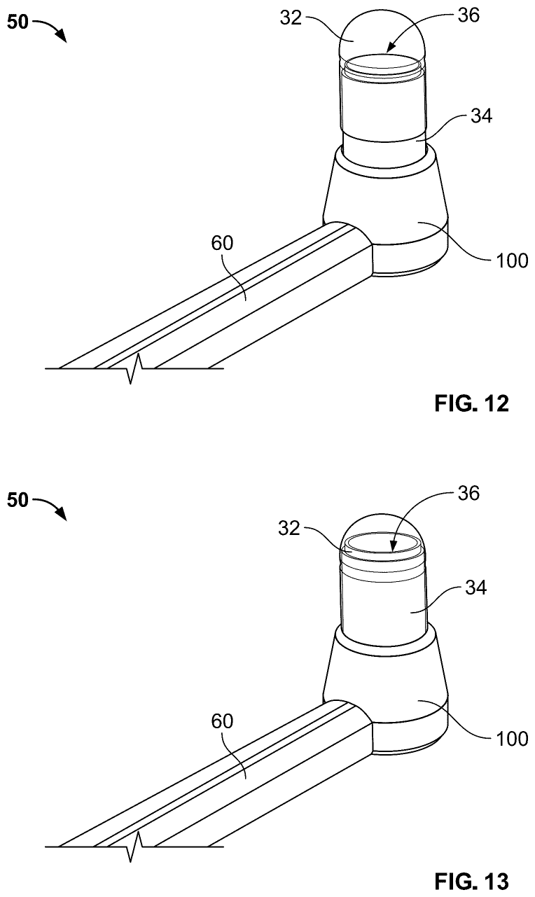

Furthermore, attaching the cap 32 and the body 34 to the tool 50 streamlines the weighing process. For example, a user may desire to establish a tare weight of the empty capsule 30 to allow for an accurate determination of a net weight of a desired substance that is deposited in the capsule 30, and therefore an accurate dosage calculation. Correspondingly, the combined weight of the empty capsule 30 and the tool 50 is tared by placing the tool 50 directly on a scale, and the tool 50 is used to fill the body 34, e.g., by scooping the head 100 into a container containing a substance, before being placed on the scale and weighed again to determine the net weight of the substance added to the body 34. In this way, the tool 50 allows the capsule 30 to be weighed and filled without being removed therefrom, thereby increasing overall efficiency during encapsulation. After a desired dosage and/or fill weight has been achieved, the cap 32 is removed from the protrusion 82 and pressed onto the body 34 to seal the volume 36, as illustrated in FIGS. 12 and 13. Specifically, FIG. 12 illustrates the cap 32 being loosely placed on the body 34, and FIG. 13 illustrates the sealed capsule 30 that is formed after the cap 32 is pressed onto the body 34 to seal the volume 36. Finally, the assembled, filled capsule 30 is removed from the tool 50, e.g., by pulling the capsule 30 out of the head 100.

Referring now to FIG. 14, examples are illustrated of different filling tool sizes that correspond to the international capsule sizes 000, 00, 0, and 1 (see, e.g., FIG. 1). In particular, FIG. 14 illustrates a first example tool 202 corresponding to international capsule size 000, a second example tool 204 corresponding to international capsule size 00, a third example tool 206 corresponding to international capsule size 0, and a fourth example tool 208 corresponding to international capsule size 1. Each of the example tools 202, 204, 206, 208 includes a corresponding recess 80, protrusion 82, label 88, and head 100. It will be understood that the sizes of the recesses 80, protrusions 82, and heads 100 correspond to particular international capsule sizes to provide a tight fit with the capsules 30. That is, the recesses 80, protrusions 82, and heads 100 decrease in size from the first example tool 202 to the fourth example tool 208. Further, the labels 88 depict the international capsule sizes that the example tools 202, 204, 206, 208 are configured for, e.g., 000, 00, 0, and 1, respectively. It will be understood that filling tools corresponding to the other international capsule sizes, e.g., 2, 3, 4, and 5, can also be provided.

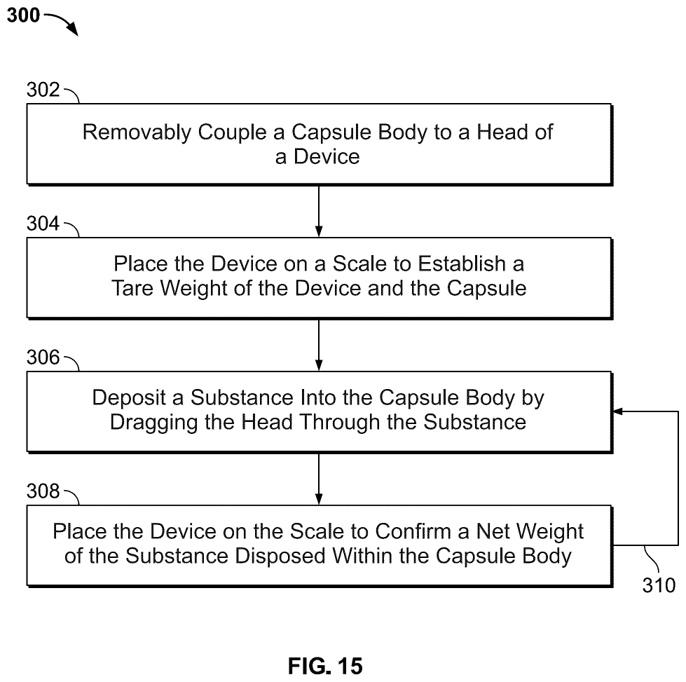

FIG. 15 depicts a flowchart illustrating a method 300 for filling and weighing a capsule with the tool 50. While the example process is described with reference to the flowchart illustrated in FIG. 15, various other methods of assembling the tool 50 may alternatively be used. For example, the order of execution of the blocks may be rearranged, changed, eliminated, and/or combined to perform the method 300. Step 302 of the method 300 includes removably coupling the body 34 of the capsule 30 to the head 100 of the tool 50. As discussed above, this is accomplished by inserting the body 34 into the aperture 116 to create an interference fit that secures the body 34 to the head 100. In some aspects, the inner wall 118 of the head 100 tapers inward at the bottom end 112 to define the lower rim 120, and the interference fit is created by pressing the body 34 downward into the aperture 116. In particular, the tapered profile of the inner wall 118 deforms the body 34, thus preventing the body 34 from dislodging from the head 100 unless intentionally removed by a user, i.e., preventing the body 34 from dislodging due to gravity. In some examples, the method further includes pressing the cap 32 onto the protrusion 82, as discussed above.

Step 304 of the method 300 includes placing the tool 50 on a scale to establish a tare weight of the capsule 30 and the tool 50. That is, the combined weight of the capsule 30 and the tool 50 is tared as a single component, which streamlines the weighing process in comparison to conventional capsule filling techniques. Further, step 306 of the method 300 includes depositing a desired substance into the body 34, i.e., into the volume 36 defined by the body 34, by dragging or scooping the head 100 of the tool 50 through the substance. For example, the head 100 is inserted into a container and moved in a scooping motion to capture a quantity of the desired substance in the body 34. In this way, the tool 50 eliminates the need to separately: scoop a desired substance with a separate tool, e.g., a lab spatula; stabilize or hold the body 34; and pour the scooped substance into the body 34. Put another way, the tool 50 allows a user to scoop a substance directly into the body 34 with one hand, i.e., without holding the capsule 30 with one's hand.

Further, step 306 of the method 300 includes placing the tool 50 back on the scale to confirm a net weight of the substance disposed within the body of the capsule after filling has occurred. Due to the previous step 304 of taring the weight of the empty capsule 30 and the tool 50, weighing the filled capsule 30 and the tool 50 returns a net weight of the substance, thus further simplifying the weighing process. It is contemplated that steps 306, 308 are repeated until a desired net weight, i.e., a desired dosage, is achieved, as indicated by arrow 310. Once the desired net weight is achieved, the method 300 includes reassembling the capsule 30 and removing the filled or completed capsule from the tool 50. Specifically, the cap 32 is removed from the protrusion 82 and attached to the body 34 to encapsulate the desired substance. As discussed above, pressing the cap 32 onto the body 34 with sufficient force creates a mechanical seal therebetween, which completely seals the volume 36 from the ambient environment. Finally, the completed capsule 30 is removed from the tool 50, where it can be loaded onto the recess 80 or otherwise put aside while another capsule is loaded onto the tool 50 and the method 300 is repeated.

In other embodiments, other configurations are possible. For example, certain features and combinations of features that are presented with respect to particular embodiments in the discussion above can be utilized in other embodiments and in other combinations, as appropriate. Further, any of the embodiments described herein may be modified to include any of the structures or methodologies disclosed in connection with other embodiments. Additionally, the present disclosure is not limited to filling tools of the type specifically shown. Still further, aspects of the filling tools of any of the embodiments disclosed herein may be modified to work with other devices or components not specifically discussed herein.

As noted previously, it will be appreciated by those skilled in the art that while the disclosure above has been described above in connection with particular embodiments and examples, the disclosure is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the disclosure are set forth in the following claims.

### INDUSTRIAL APPLICABILITY

Numerous modifications to the present disclosure will be apparent to those skilled in the art in view of the foregoing description. Accordingly, this description is to be construed as illustrative only and is presented for the purpose of enabling those skilled in the art to make and use the embodiments of the disclosure. The exclusive rights to all modifications which come within the scope of the appended claims are reserved.

I claim:

1. A device for weighing and filling a capsule, the device comprising:
a handle defining an outer side and an inner side;
a panel coupled to the inner side of the handle at a first end thereof;
a shaft coupled to the first end of the handle and extending away therefrom; and
a head coupled to a distal end of the shaft,
wherein the head defines an aperture that is configured to receive a body of a capsule therein.

2. The device of claim 1, wherein the head includes a conical portion that extends upward from a cylindrical portion, the conical portion defining an upper rim at a top end of the head and the cylindrical portion defining a lower rim at a bottom end of the head.

3. The device of claim 2, wherein the head includes an inner wall that tapers inward at the bottom end of the head to define the lower rim.

4. The device of claim 2, wherein the upper rim defines a first diameter that is greater than a second diameter defined by the lower rim.

5. The device of claim 4, wherein the first diameter is between 100% and 125% of the second diameter, expressed as a percentage.

6. The device of claim 1, wherein the handle is unitary with the panel and the shaft.

7. The device of claim 1, wherein the device defines a longitudinal axis that extends through the first end of the handle and a second end of the handle that is opposite the first end, and
wherein the shaft extends along the longitudinal axis.

8. The device of claim 1, wherein the panel defines a top side and a bottom side, and wherein a protrusion is coupled to the top side of the panel, the protrusion to receive a cap of the capsule thereon.

9. A device for weighing and filling a capsule, the device comprising:
a handle defining an outer side, an inner side, a first top side, and a first bottom side;
a panel coupled to the inner side of the handle at a first end thereof, the panel defining a second top side and a second bottom side;
a shaft coupled to the first end of the handle and extending away therefrom; and
a head coupled to a distal end of the shaft,
wherein the first bottom side and the second bottom side are planar, and
wherein the first bottom side is flush with the second bottom side such that the device defines a planar bottom surface.

10. The device of claim 9, wherein a protrusion is coupled to the second top side, the protrusion to receive a cap of a capsule thereon.

11. The device of claim 9, wherein an ovular recess is defined within the second top side, the ovular recess corresponding to a profile of a capsule.

12. The device of claim 9, wherein a label is disposed on the second top side, the label to indicate a size of a capsule that the device is configured to receive.

13. The device of claim 9, wherein the shaft defines a third bottom side that is planar and that is flush with the first bottom side of the handle and the second bottom side of the panel.

14. The device of claim 9, wherein the handle defines a second end that is opposite the first end, and
wherein the handle defines an ovular profile such that the first end and the second end define curved segments of the handle.

15. The device of claim 9, wherein the handle defines an opening that is enclosed by the inner side of the handle and the panel.

16. A method of filling and weighing a capsule with a device, comprising:
removably coupling a body of a capsule to a head of a device;
placing the device on a scale to establish a tare weight of the device and the capsule;
depositing a substance into the body of the capsule by dragging the head of the device through the substance; and
placing the device on the scale to confirm a net weight of the substance disposed within the body of the capsule.

17. The method of claim 16, wherein removably coupling the body of the capsule to the head includes inserting the body of the capsule into an aperture defined by the head to create an interference fit.

18. The method of claim 17, wherein an inner wall of the head tapers inward at a bottom end of the head to define a lower rim, and wherein the interference fit between the body of the capsule and the head is formed by pressing the capsule into the aperture to contact the lower rim.

19. The method of claim 16 further comprising removably coupling a cap of the capsule to a protrusion coupled to a panel of the device by pressing the cap onto the protrusion.

20. The method of claim 19 further comprising:
removing the cap from the protrusion;
attaching the cap to the body of the capsule to encapsulate the substance disposed therein; and
removing the capsule from the head of the device.
